(19) United States
(12) Patent Application Publication
(10) Pub. No.: US 2024/0150126 A1
(43) Pub. Date: May 9, 2024

(54) PHYSICAL DISTRIBUTION SYSTEM AND PROCESSING METHOD

(71) Applicant: TOYOTA JIDOSHA KABUSHIKI KAISHA, Aichi-ken (JP)

(72) Inventors: Takatoshi MORIMITSU, Toyota-shi (JP); Junya OTA, Edogawa-ku (JP); Yutaro TAKAGI, Edogawa-ku, Tokyo-to (JP); Kunihiro IWAMOTO, Nagakute-shi (JP); Uori KOIKE, Saitama-shi (JP)

(73) Assignee: TOYOTA JIDOSHA KABUSHIKI KAISHA, Aichi-ken (JP)

(21) Appl. No.: 18/490,756

(22) Filed: Oct. 20, 2023

(30) Foreign Application Priority Data
Nov. 8, 2022 (JP) 2022-178536

(51) Int. Cl. B65G 1/137; B65G 1/04

(52) U.S. Cl. CPC B65G 1/1378; B65G 1/0464; B65G 1/0485

(57) ABSTRACT

A physical distribution system includes: a creation unit configured to create a layout for storage of objects to be sorted in a storage container; an output unit configured to output the created layout; a notification unit configured to transmit, when there is, in the storage container, an object that cannot be picked up, a notice for requesting a person to take out that object to a terminal apparatus; and a pickup control unit configured to control the pickup unit so that it picks up an object that has been put in the storage container, and move the object to a sorting destination in accordance with the object, in which the creation unit creates the layout in which that only objects that are registered in advance as those that cannot be picked up are collectively stored in a predetermined storage area.

### CROSS REFERENCE TO RELATED APPLICATIONS

This application is based upon and claims the benefit of priority from Japanese patent application No. 2022-178536, filed on Nov. 8, 2022, the disclosure of which is incorporated herein in its entirety by reference.

### BACKGROUND

The present disclosure relates to a physical distribution system and a processing method.

In recent years, technologies for automatically sorting objects using robots have been developed. For example, Japanese Unexamined Patent Application Publication No. 2021-095250 discloses an automatic warehouse system including a robotic arm for taking out an object from a container. In this automatic warehouse system, when it is determined that an object cannot be grasped by the robotic arm in an autonomous operation mode, the mode is switched to a manual operation mode in which the robotic arm is manually operated by an operator through remote control. Further, when such mode switching is to be performed, a request is made to the operator to manually operate the robotic arm by displaying a request screen (e.g., a request window) in a remote terminal.

### SUMMARY

According to the technology disclosed in the aforementioned literature, when the robot cannot automatically grasp an object, a manual operation for grasping the object is performed by an operator. Therefore, even if an object that cannot be automatically grasped by the robot is contained in a container, it is possible to prevent the sorting work from being stopped or delayed for a long time. However, there is a strong need for a technology for further improving the efficiency of such sorting works.

Regarding this need, inventors of the present application have found that the efficiency of the sorting work is affected by the type or the like of an object that is contained along with an object that cannot be picked up by a robot in the container. Specifically, the inventors have found that when an object that can be picked up by a robot and an object that cannot be picked up by the robot are contained in a mixed manner in a container, the efficiency of the sorting work may decrease.

The present disclosure has been made in view of the above-described circumstances, and an object thereof is to provide a physical distribution system and a processing method capable of improving the efficiency of sorting works.

An aspect of the present disclosure for achieving the above-described object is a physical distribution system including a sorting apparatus including a pickup unit, further including: a creation unit configured to create a layout for storage of objects to be sorted in a storage container to be delivered to the sorting apparatus; an output unit configured to output the created layout; a notification unit configured to transmit, when there is, in the storage container, an object that cannot be picked up by the pickup unit, a notice for requesting a person to take out that object from the storage container to a terminal apparatus used by that person; and a pickup control unit configured to control the pickup unit so that it picks up an object that has been put in the storage container according to the layout, and move the object to a sorting destination in accordance with the object, in which the creation unit creates the layout in which, among objects to be delivered to the sorting apparatus, only objects that are registered in advance as those that cannot be picked up by the pickup unit are collectively stored in a predetermined storage area.

According to the above-described physical distribution system, when there are, in a storage container, objects to be sorted that cannot be picked up by the pickup unit, it is possible to request support from a person and thereby to prevent the sorting process from being stopped or delayed. In particular, according to the above-described physical distribution system, it is possible to prevent objects that can be grasped by the pickup unit and those that cannot be grasped by the pickup unit from being disposed in a mixed manner, and thereby to improve the efficiency of sorting works.

In the above-described aspect, the notification unit may transmit, to the terminal apparatus, the notice for requesting the person to take out the object from the storage container along with information indicating a feature for identifying the object.

According to the above-described configuration, a person who assists in the sorting work can know the feature for identifying the object, and therefore can easily specify which object the person should take out.

In the above-described aspect, the feature may be a name of the object.

According to the above-described configuration, the person assisting in the sorting work can easily specify which object he/she should take out.

In the above-described aspect, the feature may be an external feature of the object.

According to the above-described configuration, the person assisting in the sorting work can easily specify which object he/she should take out.

In the above-described aspect, the feature may be a weight of the object.

According to the above-described configuration, the person assisting in the sorting work can easily specify which object he/she should take out.

In the above-described aspect, the physical distribution system further includes a pickup determination unit configured to determine whether or not an object contained in the storage container can be picked up by the pickup unit.

According to the above-described configuration, it is possible to determine whether or not an object contained in the storage container can be picked up by the pickup unit, and thereby to determine whether or not a notice for requesting a person to take out the object is necessary at the time of the sorting work for the storage container.

In the above-described aspect, when it is detected that an area where an object to be sorted is stored is the predetermined storage area, the pickup determination unit may determine that the object cannot be picked up.

According to the above-described configuration, it is possible to collectively determine that a plurality of objects disposed in a predetermined storage area cannot be picked up by the pickup unit, and thereby to improve the efficiency of the determination process.

In the above-described aspect, the pickup control unit may control the pickup unit so that it picks up and sorts only objects stored in an area other than the predetermined storage area.

According to the above-described configuration, there is no need to attempt to pick up an object disposed in the predetermined storage area, i.e., an object that cannot be picked up by the pickup unit, so that it is possible to prevent a wasteful pickup operation from being performed.

In the above-described aspect, the physical distribution system further includes a take-out determination unit configured to determine whether or not the object to be sorted that cannot be picked up by the pickup unit has been taken out from the storage container, in which when it is determined that the object to be sorted that cannot be picked up has not been taken out from the storage container, the notification unit may transmit a notice again.

According to the above-described configuration, when an object that cannot be picked up has not been taken out by a person, a notice is transmitted again. Therefore, it is possible to request support from a person more reliably and thereby to prevent the sorting process from being stopped or delayed more reliably.

In the above-described aspect, when the layout for storage of objects including an object that cannot be picked up by the pickup unit is created, the notification unit may transmit the notice to the terminal apparatus.

According to the above-described configuration, it is possible to notify the person before delivering the storage container to the sorting apparatus.

Another aspect of the present disclosure for achieving the above-described object is a processing method performed by a physical distribution system including a sorting apparatus including a pickup unit, including: creating a layout for storage of objects to be sorted in a storage container to be delivered to the sorting apparatus; outputting the created layout; transmitting, when there is, in the storage container, an object that cannot be picked up by the pickup unit, a notice for requesting a person to take out that object from the storage container to a terminal apparatus used by that person; and controlling the pickup unit so that it picks up an object that has been put in the storage container according to the layout, and move the object to a sorting destination in accordance with the object, in which in the creation of the layout, the layout is created in such a manner that, among objects to be delivered to the sorting apparatus, only objects that are registered in advance as those that cannot be picked up by the pickup unit are collectively stored in a predetermined storage area.

According to the above-described processing method, when there are, in a storage container, objects to be sorted that cannot be picked up by the pickup unit, it is possible to request support from a person and thereby to prevent the sorting process from being stopped or delayed. In particular, according to the above-described processing method, it is possible to prevent objects that can be grasped by the pickup unit and those that cannot be grasped by the pickup unit from being disposed in a mixed manner, and thereby to improve the efficiency of sorting works.

According to the present disclosure, it is possible to provide a physical distribution system and a processing method capable of improving the efficiency of sorting works.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing a configuration of a physical distribution system according to an embodiment;

FIG. 2 is a schematic front view of a sorting apparatus;

FIG. 3 is a schematic perspective view of a box;

FIG. 4 is a block diagram showing an example of a hardware configuration of a control unit;

FIG. 5 is a schematic side view of a conveyance robot;

FIG. 6 is a block diagram showing an example of a functional configuration of a control unit of a delivery management apparatus according to a first embodiment;

FIG. 7 is a schematic perspective view of a box;

FIG. 8 is a block diagram showing an example of a functional configuration of a control unit of a sorting apparatus;

FIG. 9 is a sequence chart showing an example of a flow of operations performed by a physical distribution system according to the first embodiment;

FIG. 10 is a block chart showing an example of a functional configuration of a control unit of a delivery management apparatus according to a second embodiment; and

FIG. 11 is a sequence chart showing an example of a flow of operations performed by a physical distribution system according to the second embodiment.

### DESCRIPTION OF EMBODIMENTS

The present disclosure will be described hereinafter through embodiments of the disclosure, but the disclosure according to the claims is not limited to the below-shown embodiments. Further, all the components/structures described in the embodiments are not necessarily indispensable as means for solving the problem. Note that for clarifying the explanation, the following description and the drawings are partially omitted and simplified as appropriate. Further, the same reference numerals (or symbols) are assigned to the same elements throughout the drawings and redundant descriptions thereof are omitted as appropriate.

### First Embodiment

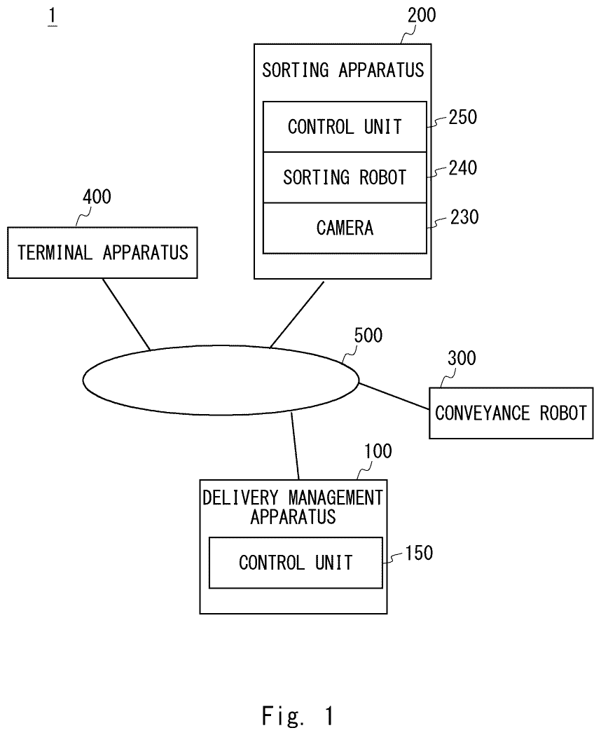

A physical distribution system 1 according to a first embodiment will be described hereinafter with reference to the drawings. FIG. 1 is a schematic diagram showing a configuration of the physical distribution system 1 according to an embodiment. The physical distribution system 1 includes a delivery management apparatus 100, a sorting apparatus 200, a conveyance robot 300, and a terminal apparatus 400. The delivery management apparatus 100, the sorting apparatus 200, the conveyance robot 300, and the terminal apparatus 400 are connected to each other through a network 500 so that they can communicate with each other. The network 500 may include a wireless network or a wired network.

The delivery management apparatus 100 is an apparatus that manages objects that are delivered to the sorting apparatus 200 and sorted there, and in this embodiment, as will be described later, it has a function of, in particular, instructing how to store objects to be delivered in a storage container. The delivery management apparatus 100 is provided, for example, in a physical distribution center, but the place where the delivery management apparatus 100 is disposed is not limited to physical distribution centers. For example, the delivery management apparatus 100 may be a server in a cloud system. The delivery management apparatus 100 includes a control unit 150.

The sorting apparatus 200 is an apparatus that sorts objects stored in storage containers. In this embodiment, the sorting apparatus 200 is formed in the form of a rack and can accommodate storage containers in which objects are stored. Note that in the present disclosure, the storage container is, for example, a box, but the storage container is not limited to boxes. The sorting apparatus 200 is disposed, for example, inside a house. The sorting apparatus 200 includes a control unit 250, a sorting robot 240 that sorts objects, and a camera 230.

The conveyance robot 300 is a robot that conveys a storage container. The conveyance robot 300 conveys a box (a storage container) from the physical distribution center to the sorting apparatus 200 and stores the box (the storage container) in the sorting apparatus 200. Further, the conveyance robot 300 takes out a box (a storage container) accommodated in the sorting apparatus 200 and conveys the box to the physical distribution center.

The terminal apparatus 400 is a terminal apparatus used by a person who manually sort objects delivered to the sorting apparatus 200. Note that the person who manually sorts objects delivered to the sorting apparatus 200 may be a user who uses objects delivered to the sorting apparatus 200. The terminal apparatus 400 may be, but is not limited to, a smartphone, a tablet-type terminal, a PC (Personal Computer), or the like. The terminal apparatus 400 includes an output apparatus and outputs a notice (which will be described later). The output apparatus may be a display or a speaker. That is, the output apparatus included in the terminal apparatus 400 may be any apparatus capable of outputting a notice to the above-described person.

Each of the delivery management apparatus 100, the sorting apparatus 200, the conveyance robot 300, and the terminal apparatus 400 includes a processor and a memory, has the function of a computer, and performs a predetermined process(es) by executing a program(s) stored in the memory.

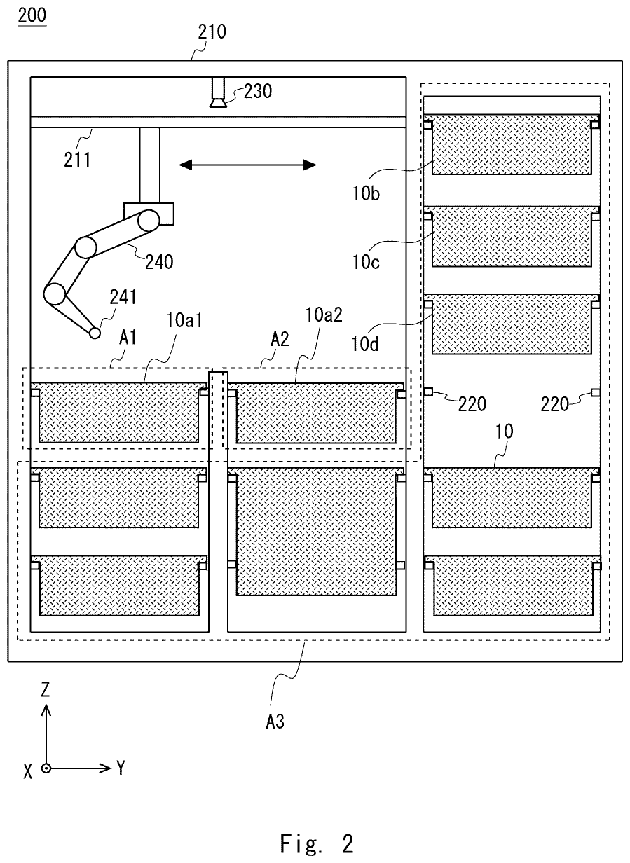

Next, the sorting apparatus 200 will be described with reference to FIG. 2. FIG. 2 is a schematic front view of the sorting apparatus 200. Note that needless to say, right-handed XYZ orthogonal coordinate systems shown in FIG. 2 and in other drawings are shown for the sake of convenience in order to explain the positional relationship among components. In general, the Z-axis positive direction is vertically upward and the XY-plane is a horizontal plane, which are common throughout the drawings. The sorting apparatus 200 includes a housing 210, a plurality of pairs of rails 220, a camera 230 and a sorting robot 240.

The housing 210 includes a top plate disposed on the Z-axis positive side, a bottom plate disposed on the Z-axis negative side, and side plates disposed on the Y-axis positive and negative sides. The housing 210 further includes a guide rail 211 for attaching the sorting robot 240 thereto. Further, the camera 230 is attached to the top plate.

The plurality of pairs of rails 220 extend in the depth direction (X-axis direction) and are equally spaced in the height direction (Z-axis direction) inside the housing 210. A plurality of boxes 10 are accommodated along the plurality of pairs of rails 220.

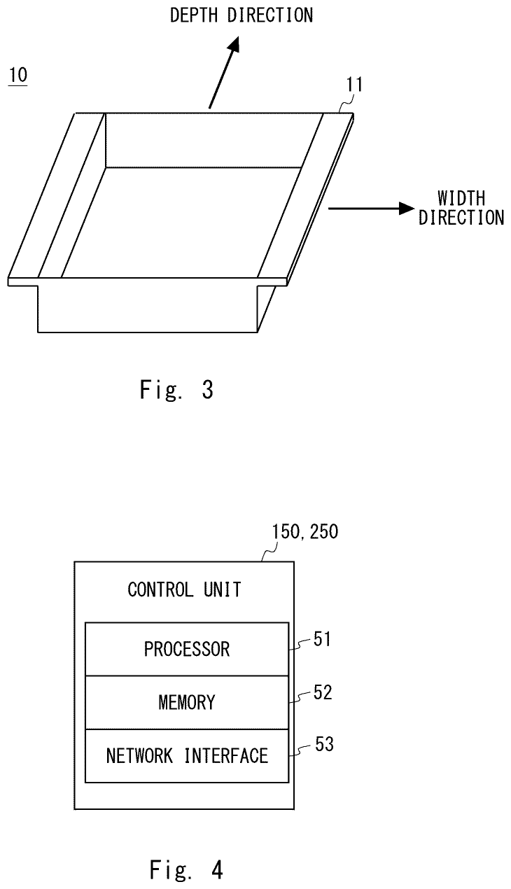

FIG. 3 is a schematic perspective view of a box 10. As shown in FIGS. 2 and 3, the box 10 includes projecting parts 11 which project in the width direction (Y-axis direction) of the box 10. The projecting parts 11 extend in the depth direction (X-axis direction) of the box 10. One of the projecting parts 11 is supported by one of a pair of rails 220 and the other of the projecting parts 11 is supported by the other of the pair of rails 220. Note that the bottom surface of the box 10 may be supported by a pair of rails 220. In such a case, the box 10 may not include the projecting parts 11.

As described above, the sorting apparatus 200 is formed so as to be able to accommodate a plurality of boxes 10. The sorting apparatus 200 shown in FIG. 2 includes an accommodation area A1, an accommodation area A2, and an accommodation area A3. The accommodation area A1 is an area where a box 10a1 is accommodated, the accommodation area A2 is an area where a box 10a2 is accommodated. The accommodation area A3 is an area other than the accommodation areas A1 and A2. Boxes 10b, 10c, and 10d are accommodated in the accommodation area A3.

The accommodation areas A1 and A2 are areas that the sorting robot 240 can approach. Boxes from which sorting is performed are disposed in one of the accommodation areas A1 and A2, and boxes into which the sorting is performed are disposed in the other of them. In the following description, a case in which the boxes from which sorting is performed are disposed in the accommodation area A1, and the boxes into which the sorting is performed are disposed in the accommodation area A2 will be described. In such a case, a plurality of different types of objects are stored in the box 10a1 in a mixed manner, or a plurality of objects, which are used by a plurality of different users, are stored in the box 10a1 in a mixed manner. However, only one type of object may be stored in the box 10a1, or only objects of one user may be stored in the box 10al. In this embodiment, the box 10a1 is a box that has been delivered from the physical distribution center and is a box in which objects have been stored according to instructions from the delivery management apparatus 100.

In contrast, boxes in which objects of a predetermined type are stored and/or boxes in which objects that are used by a predetermined user are stored are disposed in the accommodation area A3. For example, emergency supplies are stored in the box 10b, and kitchen supplies are stored in the box 10c. Further, cleaning supplies are stored in the box 10d. Objects used by a father may be stored in the box 10b, and objects used by a mother may be stored in the box 10c. Further, objects used by a child (or children) may be stored in the box 10d. When a box accommodated in the accommodation area A3 is to be replenished with objects, this box is taken out and stored in the accommodation area A2, and then this box is replenished with objects by the sorting robot 240.

The camera 230 is attached to the top plate or the like of the housing 210. The camera 230 takes images of objects accommodated in the boxes 10a1 and 10a2.

The sorting robot 240, which is attached to the guide rail 211, can move in the Y-axis direction as shown by the double-sided arrow. The sorting robot 240 is a robot including a pickup unit 241. The pickup unit 241 is an end effector (a manipulator) that picks up an object. The sorting robot 240 picks up an object stored in the box 10a1 by using the pickup unit 241 and puts the object into the box 10a2. Note that the configuration of the pickup unit 241 is not limited to any particular configuration as long as the pickup unit 241 can pick up an object. For example, the pickup unit 241 may pick up an object by grasping the object, or may pick up an object by adsorbing (e.g., sucking) the object.

The sorting robot 240 is able to recognize an object by using an image taken by the camera 230. After the object is moved from the box 10a1 into the box 10a2, the box 10a2 is stored in the accommodation area A3 of the sorting apparatus 200 by the conveyance robot 300. Note that the sorting robot 240 may move the box 10.

Further, the sorting apparatus 200 includes the control unit 250 and performs a process for controlling the sorting robot 240 and a process for notifying the terminal apparatus 400. Note that details of these processes performed by the control unit 250 will be described later.

FIG. 4 is a block diagram showing an example of a hardware configuration of the control unit 250 included in the sorting apparatus 200 and the control unit 150 included in the delivery management apparatus 100. Each of the control unit 250 and the control unit 150 includes a processor 51, a memory 52, and a network interface 53. The processor 51, the memory 52, and the network interface 53 are connected to each other through a data bus or the like.

The network interface 53 is used to communicate with other apparatuses through the network 500. The network interface 53 may include, for example, a network interface card (NIC).

The memory 52 is composed of, for example, a combination of a volatile memory and a nonvolatile memory. The memory 52 is used to store software (a computer program) including at least one instruction executed by the processor 51, and data used for various processes.

The processor 51 performs processes of the control unit 250 and the control unit 150 (which will be described later) by loading the software (the computer program) from the memory 52 and executing the loaded software.

The processor 51 may be, for example, a microprocessor, an MPU (Micro Processor Unit), or a CPU (Central Processing Unit). The processor 51 may include a plurality of processors.

As described above, each of the control unit 250 and the control unit 150 is an apparatus that functions as a computer.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

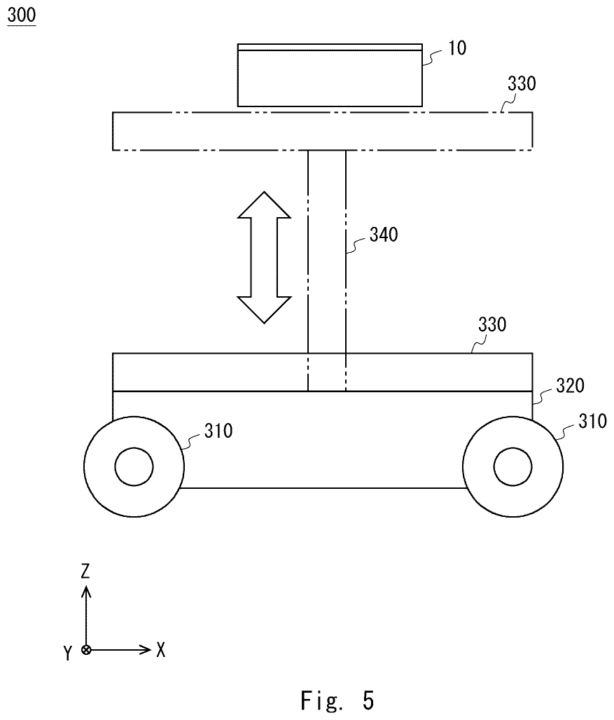

Next, the configuration of the conveyance robot 300 will be described with reference to FIG. 5. FIG. 5 is a schematic side view of the conveyance robot 300. The conveyance robot 300 includes wheels 310, a main body part 320, a top plate 330, and a support column 340. The two pairs of wheels 310, which are rotatably fixed to the lower side of the main body part 320, are driven by a drive source (not shown) such as motors.

As shown in FIG. 5, the top plate 330 is connected to the main body part 320 through the support column 340 that can be extended or contracted. The top plate 330 is connected to the upper end of the support column 340. The conveyance robot 300 places a box 10 on the top plate 330 and conveys the box 10.

The support column 340 has, for example, a telescopic type extension and contraction mechanism, and is extended and contracted by a drive source (not shown) such as a motor. As shown by the double-sided arrow, the height of the top plate 330 can be changed by changing the length of the support column 340. In this way, the conveyance robot 300 can take out boxes 10 from accommodation areas having different heights and put boxes 10 in the accommodation areas having different heights. The conveyance robot 300 can move a box 10 from the sorting apparatus 200 onto the top plate 330 by using a manipulator (not shown). Further, the conveyance robot 300 can move the box 10 from the top plate 330 into the sorting apparatus 200 by using the manipulator.

Next, the delivery management apparatus 100 will be described. The delivery management apparatus 100, which includes the control unit 150, performs a process for determining a layout for storage of objects in a storage container to be delivered and outputting the determined layout. Note that since the hardware configuration of the control unit 150 has already been described above with reference to FIG. 4, redundant descriptions are omitted.

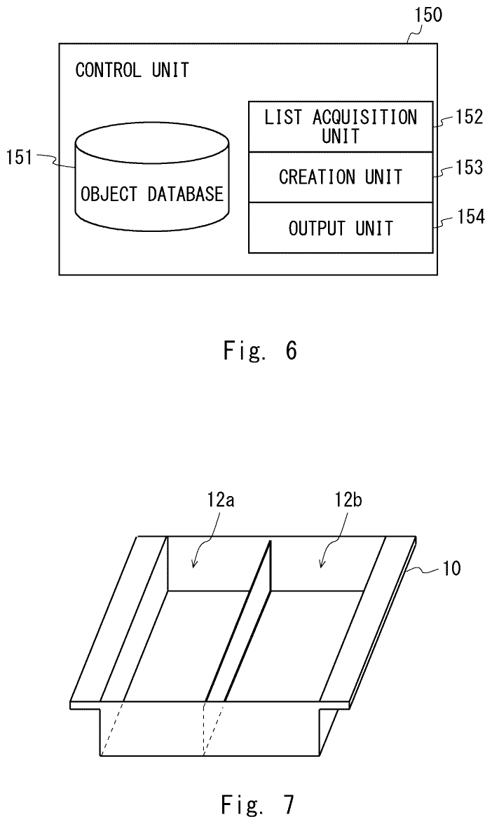

FIG. 6 is a block diagram showing an example of a functional configuration of the control unit 150 of the delivery management apparatus 100 according to the first embodiment. As shown in FIG. 6, the control unit 150 of the delivery management apparatus 100 includes an object database 151, a list acquisition unit 152, a creation unit 153, and an output unit 154.

The object database 151 is a database in which information about each of objects that could be delivered to the sorting apparatus 200 is stored. The object database 151 is composed of, for example, a memory 52 or other storage devices. The object database 151 stores, for each object, information indicating whether the object can be picked up by the pickup unit 241 of the sorting robot 240. Specifically, the object database 151 stores, for each object, identification information of the object and information indicating whether the sorting robot 240 can pick up the object in association with each other. Note that the object database 151 may further store other information as information of the object. For example, the object database 151 may store information about the appearance of the object, such as feature values used for the image recognition of the object, information about the size of the object, a name of the object, and/or information about the weight of the object. Further, the object database 151 may store, for each object, information for specifying the sorting destination of the object (e.g., a box or an area into which the object is sorted) (e.g., information specifying the category of the object or information for specifying the user of the object).

The list acquisition unit 152 acquires a list of objects that are delivered to the sorting apparatus 200 and sorted there. In other words, the list acquisition unit 152 acquires a list of objects that should be stored in a storage container that is delivered to the sorting apparatus 200. The list acquisition unit 152 may acquire the list by an arbitrary method. For example, the list acquisition unit 152 may receive a list transmitted from other apparatuses and thereby acquire the list, or may read a list stored in advance in a storage device such as the memory 52 of the delivery management apparatus 100 and thereby acquire the list. Alternatively, the delivery management apparatus 100 may acquire a list that is input, by a person, into the delivery management apparatus 100 through an input device such as a keyboard and/or a mouse (not shown).

The creation unit 153 creates a layout for storage of objects to be sorted in a storage container to be delivered to the sorting apparatus 200. Note that the layout for storage of objects includes at least information indicating in which storage area objects should be stored. The layout for storage of objects may include information indicating in which storage area and how objects should be stored. The creation unit 153 creates the layout in which, among objects to be delivered to the sorting apparatus 200, only objects that are registered in advance as those that cannot be picked up by the pickup unit 241 are collectively stored in a predetermined first storage area. More specifically, the creation unit 153 creates the layout in which, among objects to be delivered to the sorting apparatus 200, objects that are registered in advance as those that cannot be picked up are collectively stored in the predetermined first storage area, and objects that are registered in advance as those that can be picked up are collectively stored in a predetermined second storage area. In this embodiment, the creation unit 153 checks, for each of the objects included in the list acquired by the list acquisition unit 152, whether or not the object is registered, in the object database 151, as an object that can be picked up (i.e., can be picked up by the pickup unit 241) by referring to the object database 151. Then, the creation unit 153 creates a layout in which, among the objects included in the list, only objects that are registered in the object database 151 as those that cannot be picked up (i.e., cannot be picked up by the pickup unit 241) are collectively stored in the predetermined first storage area. Further, the creation unit 153 creates a layout in which, among the objects included in the list, only objects that are registered in the object database 151 as those that can be picked up (i.e., can be picked up by the pickup unit 241) are collectively stored in the second storage area different from the first storage area. Note that the layout created by the creation unit 153 needs to include only the information specifying the storage place for each object, and the data format of the layout is not limited to any particular format.

The above-described predetermined first storage area may be a storage area in a box dedicated for objects that cannot be picked up by the sorting robot 240, which is a box 10 in which only objects that cannot be picked up are permitted to be stored. In this case, the sorting robot 240 creates a layout in which, among the objects included in the list, objects that are registered as those that cannot be picked up are stored in the box dedicated for objects that cannot be picked up. Similarly, the above-described predetermined second storage area may be a storage area in a box dedicated for objects that can be picked up by the sorting robot 240, which is a box 10 in which only objects that can be picked up are permitted to be stored. In this case, the sorting robot 240 creates a layout in which, among the objects included in the list, objects that are registered as those that can be picked up are stored in the box dedicated for objects that can be picked up.

Further, the above-described predetermined first storage area may be one of partial storage areas defined by a partition in one box 10 as shown in FIG. 7. That is, the above-described predetermined first storage area may be, in a box 10 including a section 12a for objects that can be picked up and a section 12b for objects that cannot be picked up, the section 12b. In this case, the sorting robot 240 creates a layout in which, among the objects included in the list, objects that are registered as those that cannot be picked up are stored in the section 12b. Similarly, the above-described predetermined second storage area may be one of partial storage areas defined by a partition in one box 10 That is, the above-described predetermined second storage area may be, in a box 10 including a section 12a for objects that can be picked up and a section 12b for objects that cannot be picked up, the section 12a. In this case, the sorting robot 240 creates a layout in which, among the objects included in the list, objects that are registered as those that can be picked up are stored in the section 12a. According to this layout, in the box 10 shown in FIG. 7, among the objects included in the list, only objects that can be picked up are stored in the partial storage area corresponding to the section 12a, and only objects that cannot be picked up are stored in the partial storage area corresponding to the section 12b.

The output unit 154 outputs the layout created by the creation unit 153 in order to inform an operator (or a worker) or the like, who is engaged in a work for storing objects included in the list acquired by the list acquisition unit 152 in the box 10, how to store each of the objects. As the output of the layout, the output unit 154 may display the layout on a display or may transmit the layout to other apparatuses (e.g., a terminal apparatus carried by an operator who is engaged in a work for storing objects). An operator in the physical distribution center stores each of the objects included in the list in a box 10 according to the layout output from the output unit 154. Note that although the storage of objects in the box is performed by an operator in this embodiment, the storage of objects in the box may be performed by an apparatus. In this case, the output unit 154 may output the layout to this apparatus.

The box 10, in which the objects have been stored according to the output layout, is delivered from the physical distribution center to the sorting apparatus 200 by the conveyance robot 300. Therefore, the sorting work by the sorting apparatus 200 is performed for the objects stored in the box 10. Note that the delivery from the physical distribution center to the sorting apparatus 200 may be performed by using a conveyance robot other than the conveyance robot 300. That is, the delivery from the physical distribution center to the sorting apparatus 200 may be performed through a relay by a plurality of types of conveyance robots. Further, the delivery from the physical distribution center to the sorting apparatus 200 does not necessarily have to be performed by a conveyance robot(s), and may instead be performed by a person(s).

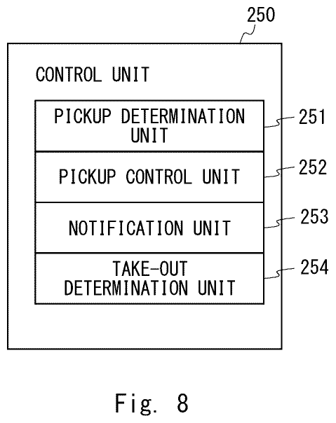

Next, the process performed by the control unit 250 of the sorting apparatus 200 will be described. FIG. 8 is a block diagram showing an example of a functional configuration of the control unit 250 of the sorting apparatus 200. As shown in FIG. 8, the control unit 250 of the sorting apparatus 200 includes a pickup determination unit 251, a pickup control unit 252, a notification unit 253, and a take-out determination unit 254.

The pickup determination unit 251 determines whether or not objects in the box 10 can be picked up by the pickup unit 241. The pickup determination unit 251 determines whether or not objects to be sorted can be picked up by the pickup unit 241 by, for example, performing an image recognition process on an image of the objects contained in the box 10 taken by the camera 230. In this case, the pickup determination unit 251 may determine whether or not the object to be sorted can be picked up by the pickup unit 241 based on the shape or size of the object specified by the image recognition process. Further, the pickup determination unit 251 may determine whether or not the object to be sorted can be picked up by the pickup unit 241 based on whether or not the object specified by the image recognition process has been registered in advance as an object that can be picked up by the pickup unit 241. Note that in this case, the pickup determination unit 251 may refer to the object database 151 of the delivery management apparatus 100. Further, the pickup determination unit 251 may determine whether or not the object to be sorted can be picked up by the pickup unit 241 by actually attempting to pick up the object by using the pickup unit 241.

Further, when it is detected (i.e., determined) that the area where the object to be sorted is stored is the above-described predetermined first storage area, the pickup determination unit 251 may determine that the object cannot be picked up (i.e., cannot be picked up by the pickup unit 241).

According to the above-described configuration, it is possible to collectively determine that a plurality of objects disposed in the predetermined first storage area cannot be picked up, and thereby to improve the efficiency of the determination process. Similarly, when it is detected (i.e., determined) that the area where the object to be sorted is stored is the above-described predetermined second storage area, the pickup determination unit 251 may determine that the object can be picked up (i.e., can be picked up by the pickup unit 241). Note that the pickup determination unit 251 detects (i.e., determines) whether the area where the object to be sorted is stored is the first storage area or the second storage area by, for example, performing an image recognition process on an image of the storage area of the box 10 taken by the camera 230. In this case, it is assumed that the first and second storage areas have, as their external features, features different from each other. For example, the first and second storage areas may have colors different from each other. Alternatively, cords different from each other (e.g., two-dimensional codes different from each other) may be stuck on the surfaces of the first and second storage areas, respectively. Note that the above-described features are merely examples. That is, the pickup determination unit 251 does not necessarily have to detect whether the area in which the object to be sorted is stored is the first storage area or the second storage area based on the result of the processing on the image obtained by the camera 230, and may instead perform the above-described detection by using a result of sensing performed by other arbitrary sensors.

The pickup control unit 252 controls the pickup unit 241 so that it picks up an object put in the box 10 according to the above-described layout and move the object to the sorting destination in accordance with the object. In this embodiment, prior to the control of the pickup unit 241 by the pickup control unit 252, the box 10 in which objects have been stored according to the above-described layout is disposed in the accommodation area A1 of the sorting apparatus 200 by the conveyance robot 300, and a box(es) 10 into which the sorting is performed (i.e., a box(es) 10 into which objects stored in the aforementioned box 10 are sorted) is disposed in the accommodation area A2 by the conveyance robot 300. In this case, for example, the conveyance robot 300 disposes, according to the information specifying the sorting destinations of objects identified by the image recognition process performed on the image of the objects contained in the box 10 disposed in the accommodation area A1 taken by the camera 230, the box 10 into which the sorting is performed in the accommodation area A2. Note that the conveyance robot 300 may acquire the information specifying the sorting destinations of the identified objects by referring to the object database 151 of the delivery management apparatus 100.

Note that the pickup control unit 252 may control the pickup unit 241 so that it picks up and sorts only the objects stored in the area other than the above-described predetermined first storage area. In other words, the pickup control unit 252 may control the pickup unit 241 so that it picks up and sorts only the objects stored in the predetermined second storage area.

According to the above-described configuration, no attempt to pick up an object disposed in the predetermined first storage area, i.e., an object that cannot be picked up, is made, so that it is possible to prevent a wasteful pickup operation from being performed. Note that, like the pickup determination unit 251, the pickup control unit 252 detects whether the area in which the object to be sorted is stored is the first storage area or the second storage area by, for example, performing an image recognition process on an image of the storage area of the box taken by the camera 230. Note that, like the pickup determination unit 251, the pickup control unit 252 does not necessarily have to detect whether the area in which the object to be sorted is stored is the first storage area or the second storage area based on the result of the processing on the image obtained by the camera 230, and may instead perform the above-described detection by using a result of sensing performed by other arbitrary sensors.

When there is an object that cannot be picked up (i.e., cannot be picked up by the pickup unit 241) in the box 10 in which the objects to be sorted are stored, the notification unit 253 transmits a notice for requesting a person to take out that object from the box 10 to a terminal apparatus 400 used by that person. That is, when it is determined, by the pickup determination unit 251, that there is an object that cannot be picked up in the box 10, the notification unit 253 transmits a notice for requesting the person to take out the object from the box 10 to the terminal apparatus 400. Note that the notification unit 253 may transmit a notice to a terminal apparatus 400 of a user who uses the object that cannot be picked up. In this case, the notification unit 253 may acquire information specifying the user of the object identified by the image recognition process on the image of the object taken by the camera 230 by referring to the object database 151 of the delivery management apparatus 100. Further, when the list acquired by the list acquisition unit 152 includes such information, the notification unit 253 may acquire the information by referring to the list.

The notification unit 253 transmits the notice requesting the person to take out the object from the box 10 to the terminal apparatus 400 along with information indicating a feature(s) for identifying the object. Since such a process is carried out, the person who takes out the object, i.e., the person who helps the sorting work, can know the feature of the object for identifying the object, and thereby can easily specify which object he/she should take out. Note that the information indicating the feature for identifying the object may be information indicating the name of the object, information indicating an external feature of the object, or information indicating the weight of the object. As the person who takes out the object is notified of such information, he/she can easily specify (i.e., determines) which object he/she should take out. The information indicating the external feature of the object may be an image of the object taken by the camera 230, information indicating the size of the object, or information indicating the color of the object. Note that the notification unit 253 may acquire information about the object identified by the image recognition process performed on the image of the object taken by the camera 230, i.e., information indicating the name of the object, information indicating the size of the object, and information indicating the weight of the object, by referring to the object database 151 of the delivery management apparatus 100.

After the notice is transmitted, the take-out determination unit 254 determines whether or not the object to be sorted that cannot be picked up by the pickup unit 241 has been taken out from the box 10. In this embodiment, the take-out determination unit 254 determines whether or not the object that cannot be picked up has been taken out from the box 10 based on the result of an image recognition process performed on an image that is obtained by photographing the inside of the box 10 by the camera 230. Note that the take-out determination unit 254 may make the above-described decision by other methods. For example, when the sorting apparatus 200 includes a weight scale that measures the weight of the box 10, the take-out determination unit 254 may determine, after the notice is transmitted, whether or not the object that cannot be picked up has been taken out from the box 10 based on whether or not the weight of the box 10 has decreased. When it is determined, by the take-out determination unit 254, that object to be sorted that cannot be picked up has not been taken out from the box 10, the notification unit 253 transmits a notice again. Specifically, when it is determined that the object to be sorted that cannot be picked up has not been taken out from the box 10 after a predetermined period of time has elapsed from the transmission of the notice, the notification unit 253 transmits a notice again.

Upon receiving the notice from the notification unit 253, the terminal apparatus 400 outputs a notice indicating the reception thereof. The terminal apparatus 400 outputs the notice, for example, to the display of the terminal apparatus 400. Note that the terminal apparatus 400 may output the notice together with a predetermined notification sound. Further, the terminal apparatus 400 may output the notice in the form of voice sound.

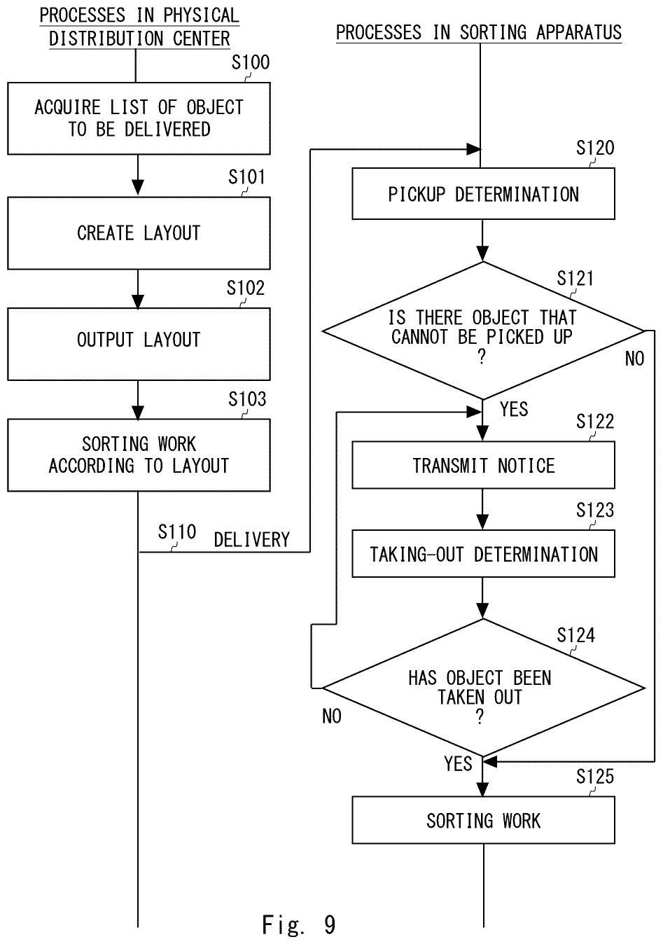

Next, an example of a flow of operations performed by the physical distribution system 1 according to this embodiment will be described. FIG. 9 is a sequence chart showing an example of a flow of operations performed by the physical distribution system 1 according to this embodiment. The flow of operations performed by the physical distribution system 1 will be described hereinafter with reference to FIG. 9.

Firstly, processes in steps S100 to S103 are performed at a physical distribution center.

In the step S100, the list acquisition unit 152 of the delivery management apparatus 100 acquires a list of objects that are to be delivered to the sorting apparatus 200 and sorted there.

Next, in the step S101, the creation unit 153 of the delivery management apparatus 100 creates a layout for storage of objects to be sorted in the box 10 that is delivered to the sorting apparatus 200. Specifically, the creation unit 153 creates a layout in which objects that are registered in advance as those that cannot be picked up are collectively stored in a predetermined first storage area, and objects that are registered in advance as those that cannot be picked up are collectively stored in a predetermined second storage area.

Next, in the step S102, the output unit 154 of the delivery management apparatus 100 outputs the layout created in the step S101.

Next, in the step S103, an operator of the physical distribution center stores each of the objects included in the list in the box 10 according to the layout output from the output unit 154.

Next, in a step S110, the box 10 in which the objects have been stored according to the layout is delivered from the physical distribution center to the sorting apparatus 200 by the conveyance robot 300. Then, the conveyance robot 300 disposes the box 10, which has been delivered from the physical distribution center, in an accommodation area A1 of the sorting apparatus 200 and disposes a box(es) 10 into which the sorting is performed (i.e., a box(es) 10 into which objects stored in the aforementioned box 10 are sorted) in an accommodation area A2.

Next, processes in steps S120 to S125 are performed in the sorting apparatus 200.

In the step S120, the pickup determination unit 251 of the sorting apparatus 200 determines whether or not the objects to be sorted, which are put in the delivered box 10, can be picked up by the pickup unit 241. When it is determined that there is an object that cannot be picked up by the pickup unit 241 in the box 10 (Yes in Step S121), the process proceeds to the step S122, whereas when it is determined that there is no such object (No in Step S121), the process proceeds to the step S125.

In the step S122, the notification unit 253 of the sorting apparatus 200 transmits, to the terminal apparatus 400, a notice for requesting a person to take out the object that cannot be picked up from the box 10.

When a predetermined time elapses from the transmission of the notice, the take-out determination unit 254 of the sorting apparatus 200 determines whether or not the object that cannot be picked up has been taken out from the box 10 in the step S123. When it is determined that the object that cannot be picked up has been taken out from the box 10 (Yes in Step S124), the process proceeds to the step S125. On the other hand, when it is determined that the object that cannot be picked up has not been taken out from the box 10 (No in Step S124), the process returns to the step S122 and the notification unit 253 transmits the above-described notice again.

In the step S125, the pickup control unit 252 of the sorting apparatus 200 controls the pickup unit 241 so as to pick up objects stored in the box 10 delivered from the physical distribution center and moves the objects to the sorting-destination box 10 (i.e., the box 10 into which objects stored in the aforementioned box 10 are sorted).

Note that although the process in the step S125 is performed after the object that cannot be picked up is taken out from the box 10 by the person in the above-described sequence chart, the process in the step S125 may be performed at other timings. For example, the process in the step S125 may be performed in parallel with the processes in the steps S122 to S124.

The first embodiment has been described above. In the physical distribution system 1 according to this embodiment, a layout in which only objects that cannot be picked up by the pickup unit 241 are collectively stored in a predetermined storage area is created and output. Further, when there is an object that cannot be picked up (i.e., cannot be picked up by the pickup unit 241) in the box 10, the notification unit 253 transmits, to the terminal apparatus 400, a notice for requesting a person to take out that object. Then, the pickup control unit 252 controls the pickup unit 241 so as to pick up and sort the objects put in the box 10 according to the created layout. According to the above-described physical distribution system 1, it is possible to request support from a user and thereby to prevent the sorting process from being stopped or delayed, which would otherwise be caused by the situation in which the sorting apparatus 200 cannot perform the sorting work for the object that cannot be picked up. Further, according to the above-described layout, it is possible to prevent objects that can be picked up and objects that cannot be picked up from being disposed in a mixed manner in the box 10, and thereby to improve the efficiency of the sorting work. In particular, since objects that should be taken out by a person are collectively disposed in a predetermined storage area, a person who takes out objects from the box 10 and sorts them, instead of making the sorting apparatus 200 sort them, can efficiently perform the sorting work as compared to the cases where such objects are disposed in a random manner, so that the workload of this person can be reduced.

Further, in this embodiment, the sorting apparatus 200 includes the pickup determination unit 251 that determines whether or not objects in the box 10 can be picked up by the pickup unit 241. Therefore, since the pickup determination unit 251 of the sorting apparatus 200 determines whether or not objects in the box 10 can be picked up, it is possible to determine whether a notice for requesting a person to take out an object is necessary at the time of the sorting work for the box 10. Further, in this embodiment, the sorting apparatus 200 includes the take-out determination unit 254 that determines whether or not an object has been taken out from the box 10, and when it is determined that the object that cannot be picked up has not been taken out, the notification unit 253 transmits a notice again.

According to the above-described configuration, when an object that cannot be picked up has not been taken out by a person, a notice is transmitted again, so that it is possible to request support from a person more reliably and thereby to prevent the sorting process from being stopped or delayed more reliably.

### Second Embodiment

In the first embodiment, the sorting apparatus 200 transmits a notice. A second embodiment differs from the first embodiment in that a delivery management apparatus 100 transmits a notice. Parts of the configuration and processes different from those of the first embodiment will be described hereinafter, and redundant descriptions will be omitted as appropriate.

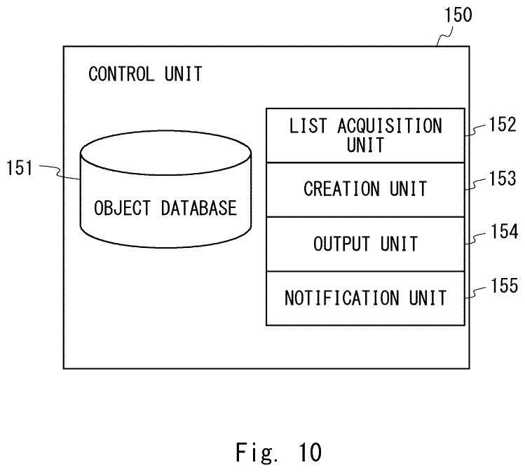

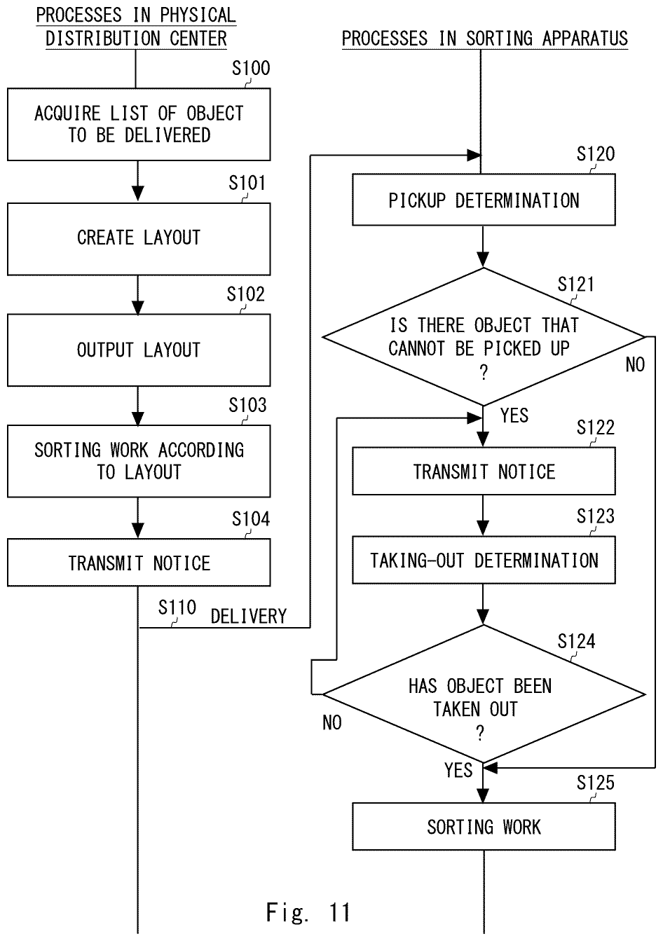

FIG. 10 is a block diagram showing an example of a functional configuration of a control unit 150 of a delivery management apparatus 100 according to the second embodiment. As shown in FIG. 6, the control unit 150 of the delivery management apparatus 100 according to the second embodiment differs from that of the first embodiment in that the control unit 150 further includes a notification unit 155.

When a layout for storage of objects including an object that cannot be picked up by the pickup unit 241 is created by the creation unit 153, the notification unit 155 transmits a notice for requesting a person to take out such an object that has been stored in the box 10 according to this layout to a terminal apparatus 400 used by this person. Note that like the notification unit 253, the notification unit 155 may transmit this notice to the terminal apparatus 400 along with information indicating a feature(s) for identifying the object that the person should take out. Further, the notification unit 155 may transmit this notice along with information indicating a timing at which the person should take out the object. The information indicating the timing at which the person should take out the object may be information indicating a timing at which the box 10 arrives at the sorting apparatus 200. Further, the notification unit 155 may transmit this notice along with information for identifying the box 10.

Next, an example of a flow of operations performed by the physical distribution system 1 according to this embodiment will be described. FIG. 11 is a sequence chart showing an example of a flow of operations performed by the physical distribution system 1 according to this embodiment. Differences from the sequence chart shown in FIG. 9 will be described hereinafter. The sequence chart shown in FIG. 11 differs from that shown in FIG. 9 in that a step S104 is added after the step S103.

In this embodiment, after the step S103, the process proceeds to the step S104. In the step S104, when a layout for storage of objects including an object that cannot be picked up is created, the notification unit 155 transmits, to the terminal apparatus 400, a notice for requesting a person to take out the object that cannot be picked up by the pickup unit 241. Note that the timing at which the process in the step S104 is performed may be any timing after the step S101, and is not necessarily after the step S103.

The second embodiment has been described above. In this embodiment, when a layout for storage of objects including an object that cannot be picked up by the pickup unit 241 is created, the notification unit 155 transmits, to the terminal apparatus 400, a notice for requesting a person to take out the object. Therefore, it is possible notify the person before the box 10 is delivered to the sorting apparatus 200. Therefore, the person, who performs the work for taking out the object, can know the occurrence (i.e., the necessity) of such work in advance, so that it becomes more convenient. Further, since the notice can be made earlier than that in the case where the notice is made from the sorting apparatus 200, it is possible to prevent the sorting process from being stopped or delayed more effectively. Note that in this embodiment, the notice by the notification unit 253 of the sorting apparatus 200 may be omitted. Further, when it is determined, by the take-out determination unit 254, that an object that cannot be picked up has not been taken out from the box 10, the notification unit 155 may transmit a notice again.

Note that the present disclosure is not limited to the above-described embodiments, and they can be modified as appropriate without departing from the scope and spirit of the disclosure. For example, although the sorting apparatus 200 is formed as a rack and the sorting robot 240 sorts objects stored in the box 10 disposed in the accommodation area A1 into the box(es) disposed in the accommodation area A2 in the above-described embodiments, the sorting apparatus 200 does not necessarily have to have a structure as a rack. That is, the sorting robot 240 does not necessarily have to be provided in the rack as long as it is a robot that can pick up an object put in a storage container by using the pickup unit 241 and move the object to a sorting destination corresponding to the object.

The whole or part of the embodiments disclosed above can be described as, but not limited to, the following supplementary notes.

### (Supplementary Note 1)

A physical distribution system comprising a sorting apparatus comprising a pickup unit, further comprising:
a creation unit configured to create a layout for storage of objects to be sorted in a storage container to be delivered to the sorting apparatus;
an output unit configured to output the created layout;
a notification unit configured to transmit, when there is, in the storage container, an object that cannot be picked up by the pickup unit, a notice for requesting a person to take out that object from the storage container to a terminal apparatus used by that person; and
a pickup control unit configured to control the pickup unit so that it picks up an object that has been put in the storage container according to the layout, and move the object to a sorting destination in accordance with the object, wherein
the creation unit creates the layout in which, among objects to be delivered to the sorting apparatus, only objects that are registered in advance as those that cannot be picked up by the pickup unit are collectively stored in a predetermined storage area.

### (Supplementary Note 2)

The physical distribution system described in Supplementary note 1, wherein the notification unit transmits, to the terminal apparatus, the notice for requesting the person to take out the object from the storage container along with information indicating a feature for identifying the object.

### (Supplementary Note 3)

The physical distribution system described in Supplementary note 2, wherein the feature is a name of the object.

### (Supplementary Note 4)

The physical distribution system described in Supplementary note 2, wherein the feature is an external feature of the object.

### (Supplementary Note 5)

The physical distribution system described in Supplementary note 2, wherein the feature is a weight of the object.

### (Supplementary Note 6)

The physical distribution system described in any one of Supplementary notes 1 to 5, further comprising a pickup determination unit configured to determine whether or not an object contained in the storage container can be picked up by the pickup unit.

### (Supplementary Note 7)

The physical distribution system described in Supplementary note 6, wherein when it is detected that an area where an object to be sorted is stored is the predetermined storage area, the pickup determination unit determines that the object cannot be picked up.

### (Supplementary Note 8)

The physical distribution system described in any one of Supplementary notes 1 to 7, wherein the pickup control unit controls the pickup unit so that it picks up and sorts only objects stored in an area other than the predetermined storage area.

### (Supplementary Note 9)

The physical distribution system described in any one of Supplementary notes 1 to 8, further comprising a take-out determination unit configured to determine whether or not the object to be sorted that cannot be picked up has been taken out from the storage container, wherein
when it is determined that the object to be sorted that cannot be picked up has not been taken out from the storage container, the notification unit transmits a notice again.

### (Supplementary Note 10)

The physical distribution system described in any one of Supplementary notes 1 to 9, wherein when the layout for storage of objects including an object that cannot be picked up by the pickup unit is created, the notification unit transmits the notice to the terminal apparatus.

### (Supplementary Note 11)

A processing method performed by a physical distribution system comprising a sorting apparatus comprising a pickup unit, the processing method comprising:
creating a layout for storage of objects to be sorted in a storage container to be delivered to the sorting apparatus;
outputting the created layout;
transmitting, when there is, in the storage container, an object that cannot be picked up by the pickup unit, a notice for requesting a person to take out that object from the storage container to a terminal apparatus used by that person; and
controlling the pickup unit so that it picks up an object that has been put in the storage container according to the layout, and move the object to a sorting destination in accordance with the object, wherein
in the creation of the layout, the layout in which, among objects to be delivered to the sorting apparatus, only objects that are registered in advance as those that cannot be picked up by the pickup unit are collectively stored in a predetermined storage area is created.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A physical distribution system comprising a sorting apparatus comprising a pickup unit, further comprising:
a creation unit configured to create a layout for storage of objects to be sorted in a storage container to be delivered to the sorting apparatus;
an output unit configured to output the created layout;
a notification unit configured to transmit, when there is, in the storage container, an object that cannot be picked up by the pickup unit, a notice for requesting a person to take out that object from the storage container to a terminal apparatus used by that person; and
a pickup control unit configured to control the pickup unit so that it picks up an object that has been put in the storage container according to the layout, and move the object to a sorting destination in accordance with the object, wherein
the creation unit creates the layout in which, among objects to be delivered to the sorting apparatus, only objects that are registered in advance as those that cannot be picked up by the pickup unit are collectively stored in a predetermined storage area.

2. The physical distribution system according to claim 1, wherein the notification unit transmits, to the terminal apparatus, the notice for requesting the person to take out the object from the storage container along with information indicating a feature for identifying the object.

3. The physical distribution system according to claim 2, wherein the feature is a name of the object.

4. The physical distribution system according to claim 2, wherein the feature is an external feature of the object.

5. The physical distribution system according to claim 2, wherein the feature is a weight of the object.

6. The physical distribution system according to claim 1, further comprising a pickup determination unit configured to determine whether or not an object contained in the storage container can be picked up by the pickup unit.

7. The physical distribution system according to claim 6, wherein when it is detected that an area where an object to be sorted is stored is the predetermined storage area, the pickup determination unit determines that the object cannot be picked up.

8. The physical distribution system according to claim 1, wherein the pickup control unit controls the pickup unit so that it picks up and sorts only objects stored in an area other than the predetermined storage area.

9. The physical distribution system according to claim 1, further comprising a take-out determination unit configured to determine whether or not the object to be sorted that cannot be picked up has been taken out from the storage container, wherein
when it is determined that the object to be sorted that cannot be picked up has not been taken out from the storage container, the notification unit transmits a notice again.

10. The physical distribution system according to claim 1, wherein when the layout for storage of objects including an object that cannot be picked up by the pickup unit is created, the notification unit transmits the notice to the terminal apparatus.

11. A processing method performed by a physical distribution system comprising a sorting apparatus comprising a pickup unit, the processing method comprising:
creating a layout for storage of objects to be sorted in a storage container to be delivered to the sorting apparatus;
outputting the created layout;
transmitting, when there is, in the storage container, an object that cannot be picked up by the pickup unit, a notice for requesting a person to take out that object from the storage container to a terminal apparatus used by that person; and
controlling the pickup unit so that it picks up an object that has been put in the storage container according to the layout, and move the object to a sorting destination in accordance with the object, wherein
in the creation of the layout, the layout in which, among objects to be delivered to the sorting apparatus, only objects that are registered in advance as those that cannot be picked up by the pickup unit are collectively stored in a predetermined storage area is created.
